(19) United States
(12) Patent Application Publication
(10) Pub. No.: US 2022/0043189 A1
(43) Pub. Date: Feb. 10, 2022

(54) OPTICAL LENS AND LENS ASSEMBLY FOR ELECTRONIC DEVICE

(71) Applicant: HON HAI PRECISION INDUSTRY CO., LTD., New Taipei (TW)

(72) Inventors: PO-CHOU CHEN, Tu-Cheng (TW); CHUN-CHENG KO, New Taipei (TW)

(21) Appl. No.: 17/118,935

(22) Filed: Dec. 11, 2020

(30) Foreign Application Priority Data
Aug. 6, 2020 (CN) 202010781446.8

(51) Int. Cl. G02B 3/00

(52) U.S. Cl. CPC G02B 3/0075; G02B 3/0062

(57) ABSTRACT

An optical lens includes a transparent portion and a flange portion surrounding the transparent portion. The flange portion includes a connecting portion, a transition portion, and an edge portion. The connecting portion is coupled between the transparent portion and the transition portion. The transition portion is coupled between the connecting portion and the edge portion. The flange portion defines a V-shaped groove. The V-shaped groove surrounds the transparent portion.

### FIELD

The subject matter herein generally relates to optical lenses, and more particularly to an optical lens and a lens assembly for an electronic device.

### BACKGROUND

Generally, imaging lenses use multiple shading films to eliminate stray light and reduce a glare phenomenon. However, a degree of reduction of the glare phenomenon by the shading films is limited, and the glare phenomenon will reduce an image quality.

### BRIEF DESCRIPTION OF THE DRAWINGS

Implementations of the present disclosure will now be described, by way of embodiments, with reference to the attached figures.

FIG. 1 is a cross-sectional diagram of a lens assembly.

FIG. 2 is a cross-sectional diagram of an optical lens shown in FIG. 1.

FIG. 3 is a partial enlarged view of a connecting portion of the optical lens shown in FIG. 2.

FIG. 4 is a partial enlarged view of a flange portion of the optical lens shown in FIG. 2.

FIG. 5 is a diagram of light rays on a V-shaped surface and a first connecting surface shown in FIG. 4.

FIG. 6 is a schematic diagram of an electronic device.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

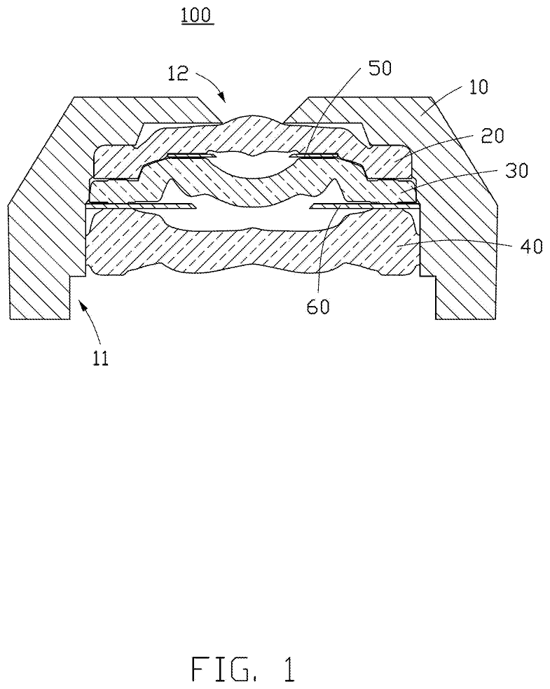

FIG. 1 shows an embodiment of a lens assembly 100. The lens assembly 100 includes a lens barrel 10, a first lens 20, an optical lens 30, and an optical lens 40. The first lens 20, the optical lens 30, and the optical lens 40 are sequentially housed and fixed in the lens barrel 10 from an object side of the lens assembly 100 to an image side of the lens assembly 100.

The lens barrel 10 defines a receiving cavity 11 and a light entrance 12. The first lens 20, the optical lens 30, and the optical lens 40 are sequentially housed and fixed in the receiving cavity 11 from the object side to the image side. The light entrance 12 communicates with the receiving cavity 11. An inner diameter of the light entrance 12 is smaller than an inner diameter of the receiving cavity 11.

The first lens 20, the optical lens 30, and the optical lens 40 have an optical axis OO′, and the first lens 20, the optical lens 30, and the optical lens 40 are axisymmetric relative to the optical axis OO′.

In one embodiment, the lens assembly 100 further includes a first shading film 50 and a second shading film 60. The first shading film 50 is located between the first lens 20 and the optical lens 30. The second shading film 60 is located between the optical lens 30 and the optical lens 40.

In one embodiment, the lens assembly 100 further includes a filter (not shown), a photosensitive element (not shown), and a circuit board (not shown).

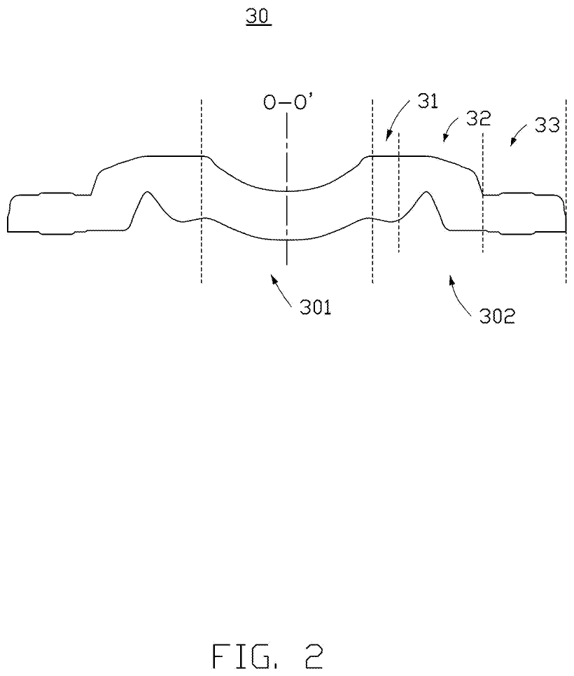

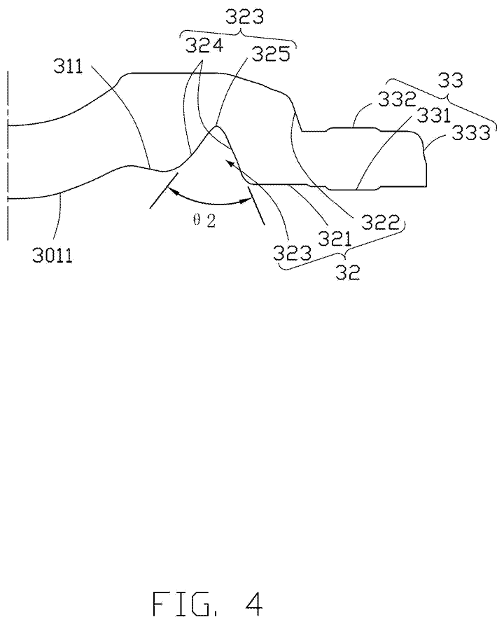

Referring to FIGS. 2-4, the optical lens 30 includes a transparent portion 301 and a flange portion 302 arranged around the transparent portion 301.

The transparent portion 301 corresponds to the light entrance 12. The transparent portion 301 includes a transparent surface 3011 facing away from the light entrance 12.

The flange portion 302 includes a connecting portion 31, a transition portion 32, and an edge portion 33. The connecting portion 31 is coupled between the transparent portion 301 and the transition portion 32, and the transition portion 32 is coupled between the connecting portion 31 and the edge portion 33.

The connecting portion 31 includes a first connecting surface 311 coupled to the transparent surface 3011.

A surface angle θ1 of the first connecting surface 311 is 15-25 degrees. The surface angle θ1 refers to an angle between the first connecting surface 311 and a positive direction of an X-axis.

The first connecting surface 311 is a polished surface.

A width of the first connecting surface 311 is 30-100 microns.

The transition portion 32 includes a first transition surface 321 and a second transition surface 322 opposite the first transition surface 321. The first transition surface 321 is located on the image side, and the second transition surface 322 is located on the object side. The first transition surface 321 is coupled to the first connecting surface 311.

The flange portion 302 defines a V-shaped groove 323 surrounding the transparent portion 301. In one embodiment, the V-shaped groove 323 is defined in the transition portion 32.

The V-shaped groove 323 is recessed from the first transition surface 321 toward the second transition surface 322.

An opening angle θ2 of the V-shaped groove 323 is 55-100 degrees, so that a portion of the light is bent outward and absorbed by the second shading film 60, and a portion of the light is reflected off the first connecting surface 311 and then absorbed by the lens barrel 10 and/or the second shading film 60.

An inner wall of the V-shaped groove 323 is a V-shaped surface 324, and two ends of the V-shaped surface 324 are respectively coupled to the first connecting surface 311 and the first transition surface 321.

The V-shaped surface 324 is a textured surface composed of multiple curved surfaces. The textured V-shaped surface 324 can scatter incident light.

The V-shaped surface 324 includes an apex point 325, which corresponds to a tip of the V-shaped groove 323.

The edge portion 33 includes a first edge surface 331, a second edge surface 332, and a third edge surface 333. The first edge surface 331 is located on the image side and coupled to the first transition surface 321. The second edge surface 332 is located on the object side and coupled to the second transition surface 322. The third edge surface 333 is coupled between the first edge surface 331 and the second edge surface 332.

The apex point 325 extends beyond the second edge surface 332, that is, a depth of the V-shaped groove 323 is greater than a distance between the first edge surface 331 and the second edge surface 332 of the edge portion 33 to prevent the incident light from directly passing through the edge portion 33 of the flange portion 302.

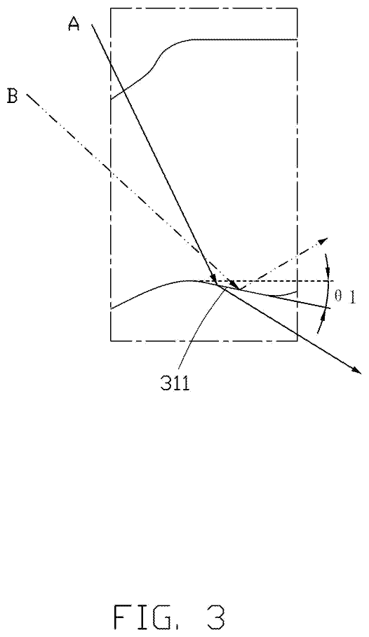

Referring to FIG. 3, light rays A and B are incident on the first connecting surface 311. A portion of the light rays (such as light ray A) is bent outward and absorbed by the second shading film 60, and a portion of the light rays (such as light ray B) is totally reflected by the first connecting surface 311 and then absorbed by the lens barrel 10 and/or the second shading film 60.

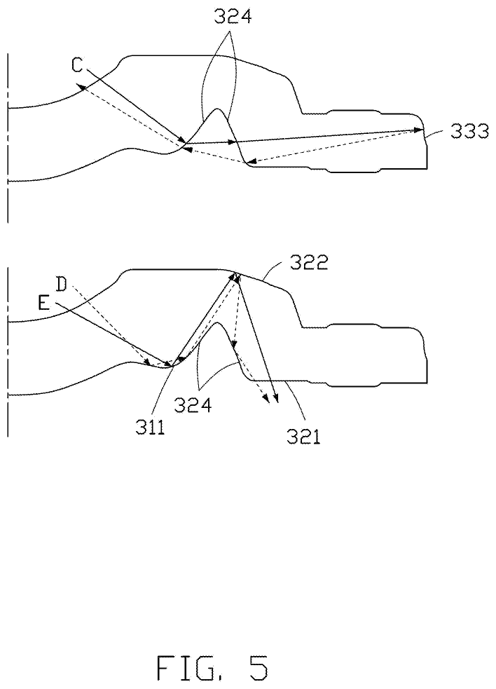

Referring to FIG. 5, a portion of the light (such as a solid line portion of a light ray C) incident on the V-shaped surface 324 of the V-shaped groove 323 will be diffused twice on the V-shaped surface 324, thereby reducing a concentration of the light and increasing a probability of absorbing the light. If the diffused light is not completely absorbed (such as a dashed line portion of the light ray C), a remaining portion of the diffused light will be reflected by the edge portion 33 and will be diffused twice again on the V-shaped surface 324, so that the light is further absorbed.

As shown in FIG. 5, a portion of the light (such as a light ray D) will be totally reflected once by the first connecting surface 311, then totally reflected once by the V-shaped surface 324, and then totally reflected once by the second transition surface 322 to transmit the light ray D to outside of the flange portion 302, and then the light ray

D is absorbed by the second shading film 60. A portion of the light (such as a light ray E) will be totally reflected in sequence by the V-shaped surface 324, the second transition surface 322, and then the V-shaped surface 324 to transmit the light ray E to outside of the flange portion 302, and then the light ray E is absorbed by the second shading film 60.

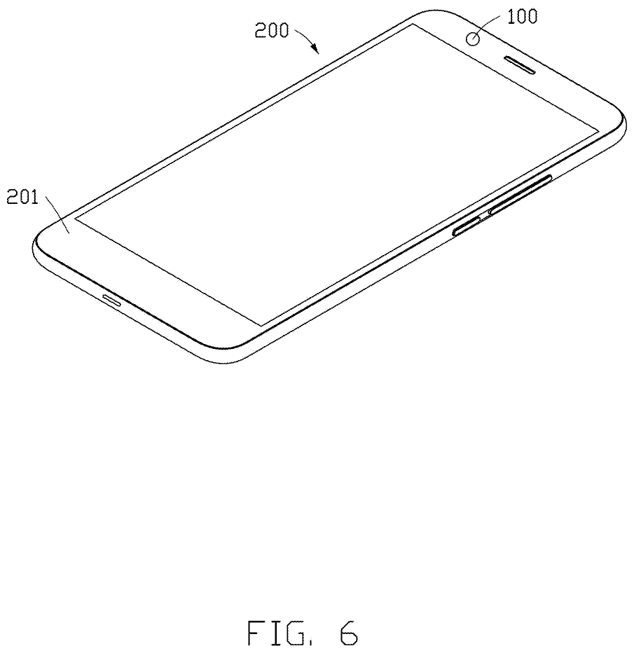

Referring to FIG. 6, the present application further provides an electronic device 200. The electronic device 200 includes a body 201. The electronic device 200 further includes at least one lens assembly 100 as described above arranged in the body 201.

In summary, the lens assembly 100 has the following advantages:

1) The flange portion is provided with the first connecting surface as described above, so that a portion of the light incident on the flange portion is bent outward and absorbed by the shading film, and a portion of the light is totally reflected by the first connecting surface and then absorbed by the lens barrel and/or the shading film.

2) The V-shaped groove as described above is defined in the flange portion, so that a portion of the light is diffused twice by the V-shaped surface, which can reduce the concentration of light and increase the absorption of the diffused light. If the diffused light is not completely absorbed, the remaining portion of the diffused light will be reflected by the edge portion and diffused twice again, so that the light is further absorbed.

3) A portion of the light can be totally reflected multiple times by the first connecting surface and the V-shaped surface, thereby transmitting the light to outside of the flange portion, and then the light is absorbed by the shading film. In this way, a glare phenomenon can be eliminated, and an imaging quality of the optical lens can be improved.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An optical lens comprising:
a transparent portion; and
a flange portion surrounding the transparent portion; wherein:
the flange portion comprises a connecting portion, a transition portion, and an edge portion;
the connecting portion is coupled between the transparent portion and the transition portion;
the transition portion is coupled between the connecting portion and the edge portion;
the flange portion defines a V-shaped groove; and
the V-shaped groove surrounds the transparent portion.

2. The optical lens of claim 1, wherein:
an inner wall of the V-shaped groove is a textured V-shaped surface.

3. The optical lens of claim 2, wherein:
the transition portion comprises a first transition surface facing an object side and a second transition surface opposite the first transition surface;
the V-shaped groove is recessed from the first transition surface toward the second transition surface;
the V-shaped groove comprises an apex point;
the edge portion comprises a first edge surface facing an image side and a second edge surface facing the object side;
the first edge surface is coupled to one end of the V-shaped surface;
the second edge surface is coupled to the second transition surface;
the apex point extends beyond the second edge surface; and
a depth of the V-shaped groove is greater than a distance between the first edge surface and the second edge surface of the edge portion.

4. The optical lens of claim 1, wherein:
an opening angle of the V-shaped groove is 55-100 degrees.

5. The optical lens of claim 2, wherein:
the connecting portion comprises a first connecting surface coupled to the V-shaped surface; and
a surface angle of the first connecting surface is 15-25 degrees.

6. The optical lens of claim 5, wherein:
the first connecting surface is a polished surface.

7. The optical lens of claim 5, wherein:
a width of the first connecting surface is 30-100 microns.

8. A lens assembly comprising:
a lens barrel;
a first lens;
a second lens; and
an optical lens, the first lens, the optical lens, and the second lens arranged in sequence from an object side to an image side and fixedly housed in the lens barrel, the optical lens comprising:
a transparent portion; and
a flange portion surrounding the transparent portion; wherein:
the flange portion comprises a connecting portion, a transition portion, and an edge portion;
the connecting portion is coupled between the transparent portion and the transition portion;
the transition portion is coupled between the connecting portion and the edge portion;
the flange portion defines a V-shaped groove; and
the V-shaped groove surrounds the transparent portion.

9. The lens assembly of claim 8, wherein:
an inner wall of the V-shaped groove is a textured V-shaped surface.

10. The lens assembly of claim 9, wherein:
the transition portion comprises a first transition surface facing an object side and a second transition surface opposite the first transition surface;
the V-shaped groove is recessed from the first transition surface toward the second transition surface;
the V-shaped groove comprises an apex point;
the edge portion comprises a first edge surface facing an image side and a second edge surface facing the object side;
the first edge surface is coupled to one end of the V-shaped surface;
the second edge surface is coupled to the second transition surface;
the apex point extends beyond the second edge surface; and
a depth of the V-shaped groove is greater than a distance between the first edge surface and the second edge surface of the edge portion.

11. The lens assembly of claim 10, wherein:
an opening angle of the V-shaped groove is 55-100 degrees.

12. The lens assembly of claim 11, wherein:
the connecting portion comprises a first connecting surface coupled to the V-shaped surface; and
a surface angle of the first connecting surface is 15-25 degrees.

13. The lens assembly of claim 12, wherein:
the first connecting surface is a polished surface.

14. The lens assembly of claim 13, wherein:
a width of the first connecting surface is 30-100 microns.

15. The lens assembly of claim 14, wherein the optical lens further comprises a first shading film and a second shading film, and the first shading film is located between the first lens and the first lens. Between the two lenses, the second shading film is located between the optical lens and the second lens.

16. An electronic device comprising a body and a lens assembly arranged in the body, the lens assembly comprising:
a lens barrel;
a first lens;
a second lens; and
an optical lens, the first lens, the optical lens, and the second lens arranged in sequence from an object side to an image side and fixedly housed in the lens barrel, the optical lens comprising:
a transparent portion; and
a flange portion surrounding the transparent portion; wherein:
the flange portion comprises a connecting portion, a transition portion, and an edge portion;
the connecting portion is coupled between the transparent portion and the transition portion;
the transition portion is coupled between the connecting portion and the edge portion;
the flange portion defines a V-shaped groove; and
the V-shaped groove surrounds the transparent portion.
